(19) United States
(12) Patent Application Publication
(10) Pub. No.: US 2021/0291202 A1
(43) Pub. Date: Sep. 23, 2021

(54) SYSTEMS, DEVICES, AND METHODS FOR CYCLONIC FILTERATION

(71) Applicant: enVerid Systems, Inc., Westwood, MA (US)

(72) Inventors: Sharon PERL-OLSHVANG, Newton, MA (US); Udi Meirav, Newton, MA (US); Shawn BROWN, Wakefield, MA (US)

(73) Assignee: enVerid Systems, Inc., Westwood, MA (US)

(21) Appl. No.: 17/272,286

(22) PCT Filed: Aug. 30, 2019
(86) PCT No.: PCT/US19/49108

§ 371 Date: Feb. 27, 2021

Related U.S. Application Data
(60) Provisional application No. 62/725,754, filed on Aug. 31, 2018.

(51) Int. Cl. B04C 5/28; B01D 45/16; B04C 5/04

(52) U.S. Cl. CPC B04C 5/28; B04C 5/04; B01D 45/16

(57) ABSTRACT

Embodiments of the present disclosure are directed to cyclonic air filtering systems for removing fine particles from an air stream. In some embodiments, small diameter cyclonic separators/elements are used to remove fine particles from an airflow where a large number of such elements are assembled together in a compact arrangement. In some embodiments, an air filtration system is presented and can comprise a housing including a plurality of compartments, an air inlet side and an air outlet side. Such a system can further include a plurality of cyclonic filtering arrays each housed in a respective compartment and each comprising an assembly of a plurality of cyclonic elements configured to filter air of an airflow via centrifugal force (i.e., cyclonic separation). The system can include mating means configured such that most, and in some embodiments, all of the airflow flows only through the arrays.

### CROSS REFERENCE TO RELATED APPLICATIONS

This application claims priority to U.S. Provisional Patent Application No.: 62/725,754 filed Aug. 31, 2018, entitled “Systems, Devices, and Methods for Cyclonic Filtration” which is incorporated by reference herein in its entirety.

### TECHNICAL FIELD

Embodiments of the present disclosure relate generally to methods, apparatuses and systems for reducing unwanted particles from gases, and in particular, to methods, apparatuses and systems including, for example, a system (which may also be referred to as an air-filter) comprising a compartmentalized housing for containing arrays of miniature cyclonic filters.

### BACKGROUND

Filtering air for removal of fine particles is important for human health, air quality, as well as industrial and mechanical applications. Many ventilation systems include air filters, the primary role of which is to capture suspended particles and prevent them from proceeding with an airflow. Cyclonic separation is an effective alternative to conventional filters for removing suspended particles from an airflow, although current separation of very fine particles from an airflow with conventionally configured cyclonic separators.

### SUMMARY OF SOME OF THE EMBODIMENTS

Accordingly, embodiments of the present disclosure include methods, apparatuses, and systems configured as, or being, an air-filter (or may also he referred to as a gas-filter, configured to filter a flow of gas), for removal of fine particles from an airflow via cyclonic separation. For example:

In some embodiments, one or more cyclonic separators are configured as an air-scrubber/filter to filter air and, in particular, capture suspended particles entrained therein. In some embodiments, to address smaller/fine particulates, small/micro-sized cyclonic separation elements are used to effectively separate and filter fine particles. Given that only such small sized cyclonic separators can be used to remove fine particles, a large number of such separators are configured as an array and operating in parallel so as to filter large volumes of air. Accordingly, in some embodiments, the arrays are assembled in single housinas/units so as to be Assembling such arrays in a small/compact volume may be, in some embodiments, a challenge in enabling practical systems for filtration of fine particles using cyclonic separation.

In some embodiments, cyclonic separators have an inner diameter of a size suitable to remove fine particles. For example, the inner diameter may be: about 10 mm or less; about 5 mm or less; about 2.5 mm or less; in the range of about 1-10 mm; in the range of about 2-10 mm, and subranges thereof; or in the range of about 2-5 mm, and subranges thereof.

In some embodiments, the inner diameter may be a diameter corresponding to that of an interior cavity of a cyclonic element itself, measured, for example, at any section from the largest to the smallest section of the cyclonic element.

In some embodiments, a system configured to compactly arrange multiple arrays of parallel cyclonic separators/elements is provided. The cyclonic elements in each array may be attached to each other (e.g., integrally formed, either via manufacturing or physical connection—e.g., adhesive, welding, and the like) so that air cannot flow across the array between the elements, but only through the elements (in some embodiments, at least partially through them). A plurality of such arrays, in some embodiments, are configured for placement in parallel compartments of a multi-compartment housing (which may also be referred to as a system). In some such embodiments, the system has an inlet side, (which may also be referred to as the front), and an outlet side, which may also be referred to as the back. Each compartment may also include an inlet on the front and an outlet on the back. In some embodiments, inside each compartment, one or more cyclonic arrays can be placed so as to separate the compartment into at least two sections, with at least one section open to the inlet, and at least one section open to the outlet. In such embodiments, air flowing through the system enters the compartments through at least one of the inlets of one side (in some embodiments, a plurality of inlets, and in some embodiments, all of the inlets), passes through at least one of the arrays (in some embodiments, a plurality of the arrays, and in some embodiments, all of the arrays), such that, the at least one array having its plurality of parallel cyclonic elements cyclonically separates particles from the airflow, and the air exits through at least one of the outlets of the other side (in some embodiments, a plurality of the outlets, and in some embodiments, all of the outlets). Thus, in some embodiments, the air is forced to pass through the cyclonic elements where it is filtered by cyclonic separation, and does not (and in some embodiments cannot) pass between the elements of an array. Such a configuration enables a large number of arrays to be configured in parallel in a relatively small volume.

In some embodiments, the arrays in the compartments can be arranged for easy removal, for replacement or clean-out (i.e., each array is configured for cleaning/removal of captured particles, then put back), by, for example, sliding within tracks, grooves or other mating features configured on the inner wall of the compartment and designed to match corresponding features on the perimeter of the arrays. Such a mating configuration can also be reversed, such that, the array can include track/grooves to receive a linearly projected structure or guide on at least one side of each compartment (preferably, on at least two sides).

In some embodiments, filtration capacity of the system/filter of configured arrays may be achieved by attaching, tiling and/or stacking multiple systems (e.g., the housing/system is at least one of attached, tiled, and stacked to an adjacent housing/system). Accordingly, airflow capacity can be addressed by such arrangement with the systems operating in parallel (e.g., like bricks in a wall), or, particle size capacity, for example, may be addressed by arranging the systems/housing to operate in series. For example, each additional system is designed/configured to remove a smaller sized particle from the airflow. In some embodiments, the system/housing can be configured to include interlocking features to facilitate the attachment or neighboring systems in such a configuration (e.g., lego® connection functionality).

In some embodiments, an air-filter is provided that can comprise at least one housing configured for placement within an airflow system, where each housing including a frame, having a plurality of frame sides, an air inlet side and an air outlet side, a plurality of isolated compartments arranged within the housing, and a plurality of cyclonic filtering arrays. At least one array can be configured to divide a respective compartment into an inlet section and an outlet section, the air inlet side of the filter includes a plurality of air inlets, each configured to provide an airflow into a respective inlet section of a respective compartment, and the air outlet side of the filter may include a plurality of air outlets, each being configured to communicate an airflow out of a respective outlet section of a respective compartment. Each array can comprise a plurality of organized, attached cyclonic separator elements, and can be configured to fit within a respective compartment such that an airflow flowing from the inlet section of the compartment to the outlet section of the compartment, flows exclusively by passing from inlets of the cyclonic elements to outlets of the cyclonic elements.

Such above-noted embodiments may include at least one of, and in some embodiments a plurality of, and in sonic embodiments, all of the following structure, functionality, step, and/or clarification, leading to yet further embodiments of the present disclosure:
at least one of the housing, the inlet side, the outlet side, and the compartments are configured such that an array can be repeatedly inserted and respectively removed in and from a compartment;
at least one frame, inlet side, or outlet side of the housing is configured to connect with a corresponding side of an adjacently placed housing, such that a plurality of housings can be assembled together to at least one of increase capacity or airflow of the filter;
a plurality of housings can be assembled together via fixed or removable attachment, and/or are configured for stacked or tiled arranaement;
a plurality of housings are connected such that airflow through each is conducted in parallel;
a plurality of housings are connected such that air cannot flow through any gaps that may be between them;
each array includes an array perimeter which mates with an inside compartment perimeter of a respective compartment;
an array is configured to mate with a respective compartment via a mating means;
   the mating means may comprise at least one of a seal, a channel arranged on at least one of the inside perimeter of each compartment and each array perimeter, and a guide arrantzed on the remaining one of each inside perimeter and each array perimeter,
      each channel can be configured to at with a respective guide;
each inlet section of each compartment can be configured to receive the airflow from a respective inlet side of the housing;
each outlet section of each compartment can he configured to expel the airflow from a respective outlet side of the housing;
and
the airflow system can comprises an HVAC (Heating, Ventilation and Air-Conditioning) system.

In some embodiments, an air-filter is provided and can comprise at least one housing configured for placement within an airflow of a building airflow system, each housing including a frame, having a plurality of frame sides, an air inlet side and an air outlet side, a plurality of isolated compartments arranged within the housing, and a plurality of cyclonic filtering arrays. Each array may comprise a plurality of organized, parallel attached cyclonic elements, each can be configured to mate with a respective compartment via a mating means, and the mating means can comprise at least one of a seal, a channel arranged on at least one of the inside perimeter of each compartment and each array perimeter, and a guide arranged on the remaining one of each inside perimeter and each array perimeter. Each channel can be configured to mate with a respective guide.

Such above-noted embodiments may include at least one of, and in sonic embodiments a plurality of, and in some embodiments, all of the following structure, functionality, step, and/or clarification, leading to yet further embodiments of the present disclosure:
at least one array can divide a respective compartment into an inlet section and an outlet section;
the air inlet side of the system can include a plurality of air inlets, each configured to provide an airflow into a respective inlet section of a respective compartment;
the air outlet side of the system includes a plurality of air outlets, each configured to communicate an airflow out of a respective outlet section of a respective compartment;
each array can be additionally configured to fit within a respective compartment such that an airflow flowing from the inlet section of the compartment to the outlet section of the compartment, flows exclusively by passing from inlets of the cyclonic elements to outlets of the cyclonic elements;

at least one of the housing, the inlet side, the outlet side, and the compartments are configured such that an array can be repeatedly inserted and respectively removed in and from a compartment,
and
at least one frame, inlet side, or outlet side of the housing can be configured to connect with a corresponding side of an adjacently placed housing, such that a plurality of housings can be assembled together to at east one of increase capacity or particle filtering size of the filter.

In some embodiments, an air-filtration method is provided, and may comprise determining a filtration requirement of an air stream, providing an air-filter/system according to any of the disclosed embodiments, configuring one or more of the air-filters/systems by assembling a plurality of the housings thereof together to form the air-filter so as to meet or exceed the filtration requirement, and placing the configured air-filter in an airflow received from the at least one room. In some embodiments, the filtration requirement comprises at least one of filtration capacity of the filter and particle size capture ability.

These embodiments and other will be even better understood in the following detailed description, as well as the drawings, a brief description of which is provided immediately below.

### BRIEF DESCRIPTION OF THE DRAWINGS

The principles and operations of the systems, apparatuses and methods according to some embodiments of the present disclosure may be better understood with reference to the drawings, and the following description. These drawings are given for illustrative purposes only and are not meant to be limiting.

FIGS. 1A-1F are schematic illustrations of an exemplary cyclonic filtering array (FIG. 1A); a cross section of an array (FIG. 1B); a cut-away illustration (FIG. 1C); a top view (FIG. 1D); a side view (FIG. 1E) and a disassembled view of an array (FIG. 1F), constructed and operative according to some embodiments of the present disclosure;

FIG. 2 is a schematic illustration of an exemplary disassembled gas filtration system, constructed and operative according to some embodiments of the present disclosure;

FIGS. 3A-3C are schematic illustrations of an exemplary sealed gas filtration system including a front view of FIG. 2 (FIG. 3A); a top view (FIG. 3B); and a side view (FIG. 3C), constructed and operative according to some embodiments of the present disclosure;

FIGS. 4A and 4B are schematic illustrations of an exemplary sealed air filtration system showing a front view of FIG. 2 (FIG. 4A) and a back view (FIG. 4B), constructed and operative according to some embodiments of the present disclosure; and

FIGS. 5A and 5B are schematic illustrations of an exemplary sealed air filtration system (FIG. 5A) and a stacked assembly of the sealed air filtration systems (FIG. 5B), according to some embodiments of the present disclosure.

### DETAILED DESCRIPTION OF AT LEAST SOME OF THE EMBODIMENTS

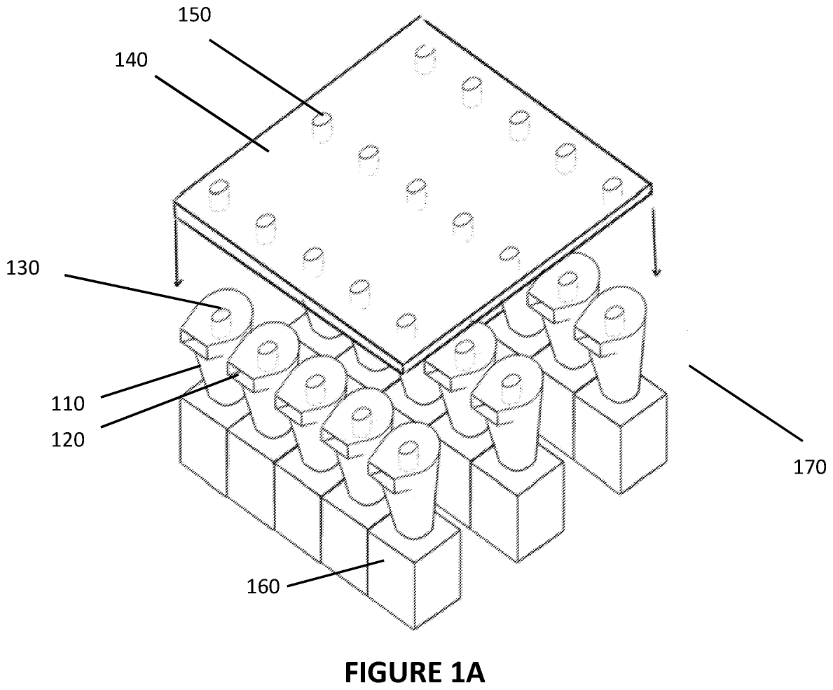

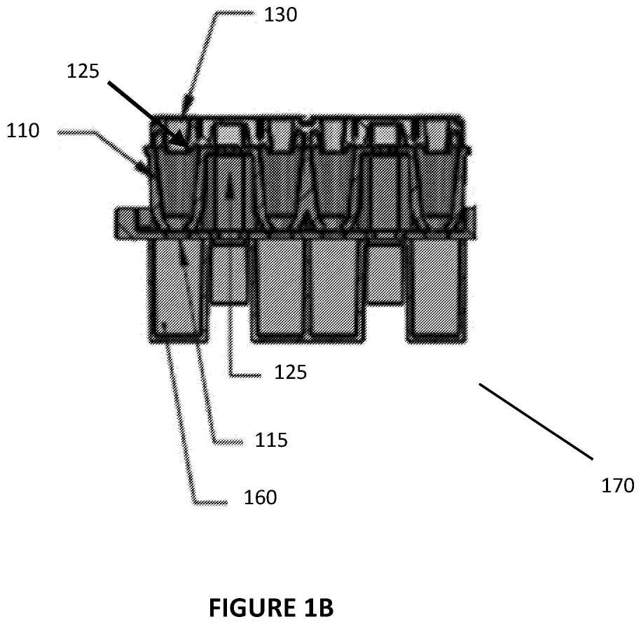

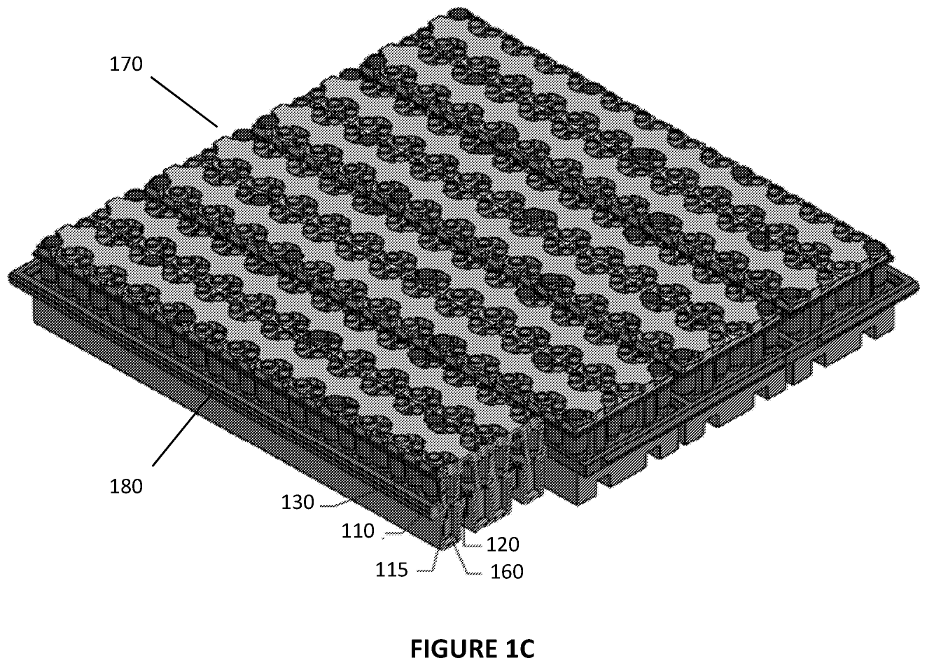

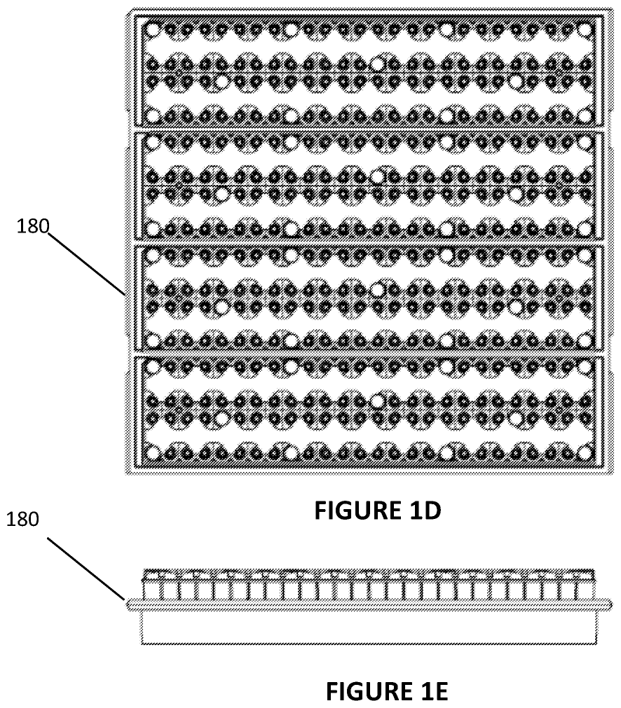

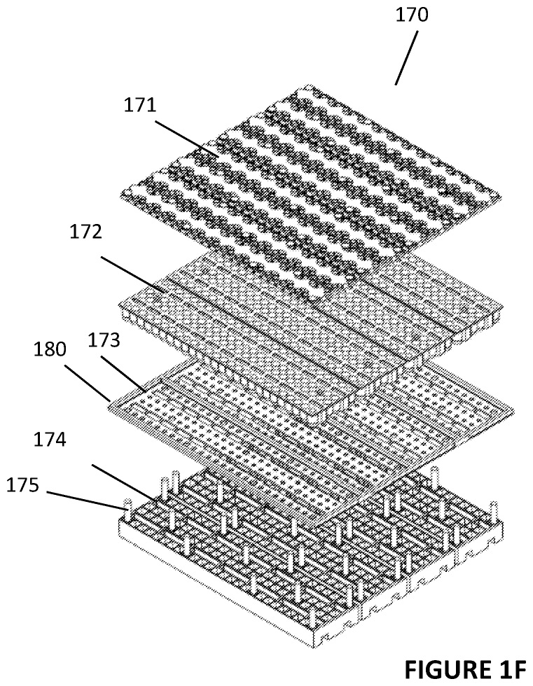

FIG. 1A shows a schematic disassembled filtering array comprising a plurality of parallel individual cyclonic scrubbers, or elements 110, arrarmed into an array 170 and attached to a common sheet 140, according to some embodiments. In some embodiments, a cyclonic element 110 includes a tangential inlet 120 that allows contaminated air or gas to flow into the element 110 for treatment according to the principles of cyclonic separation. For example, a stream of gas entering the cyclonic element 110 at high velocity) may form a vortex or a cyclone in the interior cavity of the cyclonic element 110, with the resultant centrifugal forces causing particles suspended in the gas (which may be the contaminants) to be pushed towards the interior wall of the cavity. Treated gas can exit the element 110 via an axial outlet 130 while the particles separated away from the gas accumulate in a receptacle 160 that is part of the cyclonic element 110 and may be attached to the bottom of the cyclonic cavity. In some embodiments, the cyclonic elements are attached to each other or to a common manifold or sheet 140 so that there are no air passages from one side of the array to the other (i.e, from below the array to above the array), except for through the tangential inlets and the axial outlets of the cyclonic elements.

FIG. 1B shows a cross sectional view of a part of a filtering array in a realistic manufactured device. The filtered air stream is designed to approach the array 170 from the bottom and emerge from the top. Air flows through a “dead end” gap 125 between neighboring cyclonic cells and proceeds into the cells through a tangential inlet 120 (FIG. 1A), forming a cyclone. Suspended particles are pushed to the inner wall of the cavity 110, and subsequently fall through an opening 115 into the receptacle 160, while the cleaned air emerges from the top through the axial outlet 130.

FIG. 1C shows a full view of an array 170, according to some embodiments, with a small cut-out section revealing the cross section as well as the entire array 170 showing sixteen (16) rows and 26 cells per row, fitting into a square of approximately 10 centimeters on a side. It is appreciated that the size of the entire array 170 may comprise other ranges such as rectangles (i.e., shapes, e.g., square, cylinder) with different side lengths, and any side as small as 1 cm or as large as 150 cm, or any length in the range of about 2-5 cm, or about 5-30 cm, or about 10-60 cm, or about 30-120 cm and subranges thereof in a non-limiting example. The array 170 may be shaped in any suitable shape, such as any quadrangle-type shape. The array 170 may comprise any suitable number of rows, such as in the range of about 5-1000 rows, or about 5-50 rows, or about 20-100 rows, or about 100-500 rows and subranges thereof, and any suitable number of columns, such as about 5-1000 columns, or about 5-50 columns, or about 20-100 columns, or about 100-500 columns and subranges thereof.

In sonic embodiments, like those shown in FIGS. 1C-1E, a feature may be included along the edges of the array (for example), which may be referred to as an array mating part 180, which can be configured so as to facilitate the mating or attachment of the array 170 to a groove, a track or other supporting structure inside a system where the array 170 is placed. Accordingly, mating to a corresponding structure, in sonic embodiments, not only supports the array 170 in place, but can serve to form an airtight seal (or at least substantially so) that prevents air from flowing around the array 170, thus forcing air to pass through the cells of the array 170. FIG. 1D shows a top view and FIG. 1E shows a side profile of the same array 170, showing the array mating part 180.

Some embodiments of the cyclonic filtering array 170, such as those shown in FIGS. 1B-F, can be manufactured by, for example, densely-packing cyclonic elements 110 into a monolith or a multi-layered monolith such that little or no open gaps exist between the cyclonic elements which may allow air or gas to pass between the elements 110. For example, a plurality of cyclonic elements 110 can be attached to each other or to a common sheet or surface or frame that holds the elements 110 in their place (e.g., in a densely packed arrangement) and prevents gas from flowing, through the array 170 except via the paths from the tangential inlets 120 to the axial outlets 130. In some embodiments, the sheet 140 may have openings 150 (FIG. 1A) aligned with the axial outlets 130 in the array 170 such that treated air that exits the elements 110 via the axial outlets 130 may exit the array 170 via the openings 150, but do not have any other path to get across the array 170. In some embodiments the sheet and the upper part of the cells are one and the same, and the openings 150 form and represent the axial outlets.

For example, as seen in FIG. 1F, the array 170 may comprise a monolithic array including a plurality of layers which include the features (for example) described herein. In some such embodiments, a plurality of layers (e.g., four layers) may be attached to create the array 170, with the top layer 171 defining the outlets and the inlets of the cyclonic elements, the second layer 172 defining the cyclonic cavities, a third layer 173 defining the openings between the cavities and the receptacles, and a fourth layer 174 forming the receptacles (e.g. receptacles 160 in FIG. 1A). Alignment pins 175 may also be included, and configured such that they pass through matching holes in the other layers to assure alignment and proper attachment. Formation of a monolithic array by attaching layers can be accomplished (of any number) through methods familiar to those of skill in the art, and moreover, such methods can be designed to facilitate manufacturing. In some embodiments, between 3-6 layers can be used to form the array. In some embodiments, more than 6 layers may be used, the array 170 may include sheet 140, and top layer 171 may comprise sheet 140 (FIG. 1A).

FIGS. 1B-F show an example of a cyclonic filtering array 170 according to some of the embodiments disclosed herein. Further details of some such embodiments of cyclonic filtering arrays can be found in applicant's PCT patent publication no. WO/2017/019628, filed Jul. 25, 2016, titled “Apparatus, Methods and Systems for Separating Particles from Air and Fluids,” and applicant's PCT patent publication no. WO/2018/136968, filed Jan. 23, 2018, titled “Long Life Air Filter,” both of which are incorporated herein by reference in their entireties.

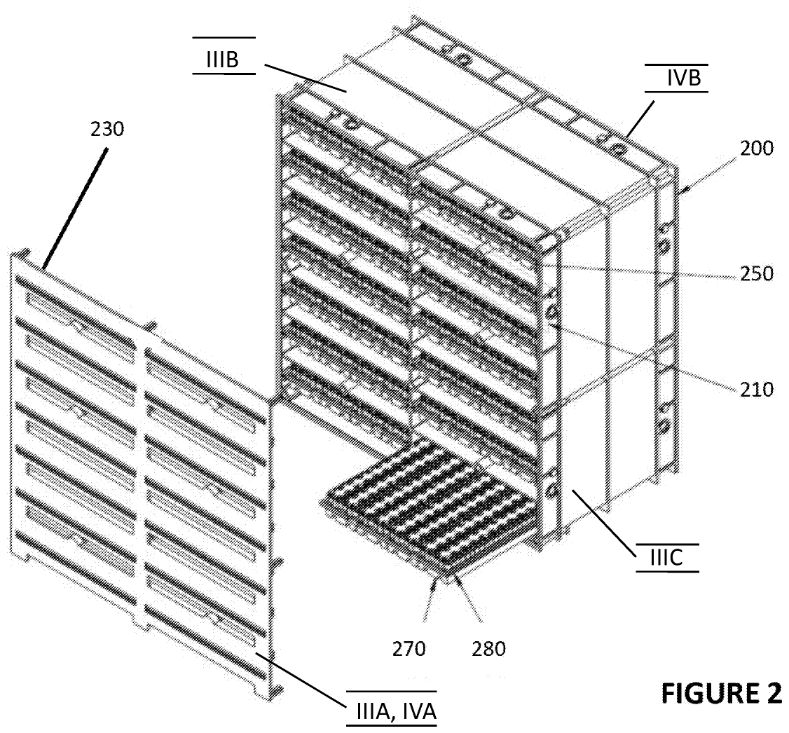

FIG. 2 shows an embodiment of a disassembled gas filtration system comprising a plurality of compartments each configured for housing a cyclonic filtering array (as shown in FIGS. 1A-E), according to some embodiments. As shown, the system includes an inlet front frame or cover 230 removed, revealing the inside of the system. In such embodiments, the filtration system 200 can include fourteen (14) compartments 210, each compartment 210 may be configured for housing one or more cyclonic filtering arrays 270, which, in some embodiments is the array 170 of FIGS. 1B-F. The array 270 can divide the compartment into two sections, namely an inlet section which is below the array, and an outlet section which is above the array. The gas filtration system 200 may comprise any number of compai talents 210, which may be determined based on the amount of air filtration needed in a particular application for which the filtration system 200 is used. In some embodiments, each compartment may include an interior perimeter having a compartment mating part 250 configured for mating with a corresponding mating part of a cyclonic filtering array 270 such that at least a substantially air-tight (i.e., hermetic) seal is formed between the inner wall of the compartments 210 and the cyclonic filtering arrays 270. For example, the cyclonic filtering array 270 may have an array perimeter that includes an array mating part 280 (e.g. mating part 180 of FIG. 1C) that is configured to mate with the compartment mating part 250.

In some embodiments, the mating between the compartment mating part 250 and the array mating part 280 may take any form that allows for the formation of a substantially airtight/hermetic seal, so that the air flows through the cyclonic array rather than around it through a gap between the array and the housing wall. For example, a compartment mating part 250 and an array mating part 280 may be a groove running around the perimeter of the compartment 210 or the array 270, respectively. In such embodiments, the other of the compartment mating part 250 and the array mating part 280 can be a matching projection correspondingly running around the respective part and configured to fit into the groove when the array 270 is fully positioned within the compartment 210, such that an airtight seal is formed between a compartment 210 and an array 270. Other types of fittings that allow for the formation of airtight seals can also be used when positioning a filtering array 270 within a compartment 210. For example, the positioning of a filtering array 270 within a compartment 210 may be such that the compartment mating part 250 overlaps the array mating part 280, forming an airtight seal. In some embodiments, the compartment mating part 250 and the array mating part 280 may be coupled to each other via another component (e.g., a rubber gasket attached to some, or all, sections of the compartment perimeter and/or the array) that also contributes to the formation of a hermetic or nearly hermetic seal. In some embodiments, the tbrm the mating or fining between the compartment mating part 250 and the array mating part 280 takes may be configured to facilitate the easy placement and/or removal of an array 270 into and/or from a compartment 210.

In some embodiments, the placement of a cyclonic filtering array 270 inside a compartment 210 divides the interior space of the compartment 210 into two sections: a first section (e.g., lower halt) which is under the array and in fluid communication with the inlets 120 (FIG. 1A) of the cyclonic elements in the filtering array 270, and a second section (e.g. upper half) that is above the array in fluid communication with the outlets 130 of the cyclonic elements in the array 270. In some embodiments, the hermetic seal between the compartment mating part 250 and the array mating part 280 at least substantially prevents the flow of gas between the two sections (e.g. when the open side of the compartment 210 in FIG. 2 is closed off with a cover 230 that also provides hermetic sealing with the edge of the array 270 facing the compartment's open side). In such embodiments, all or at least substantially all fluid communication between the two sections may take place via the paths that lead from the lower section or half (the “inlet section” which is adjacent to the inlets of the array 270 cyclonic elements) through the inlets 120 and the cyclonic cavities of the elements of the array 270 before exiting out the outlets 130 of the cyclonic elements of the array 270 into the upper section or half (the “outlet section” which is adjacent to the outlets of the cyclonic elements).

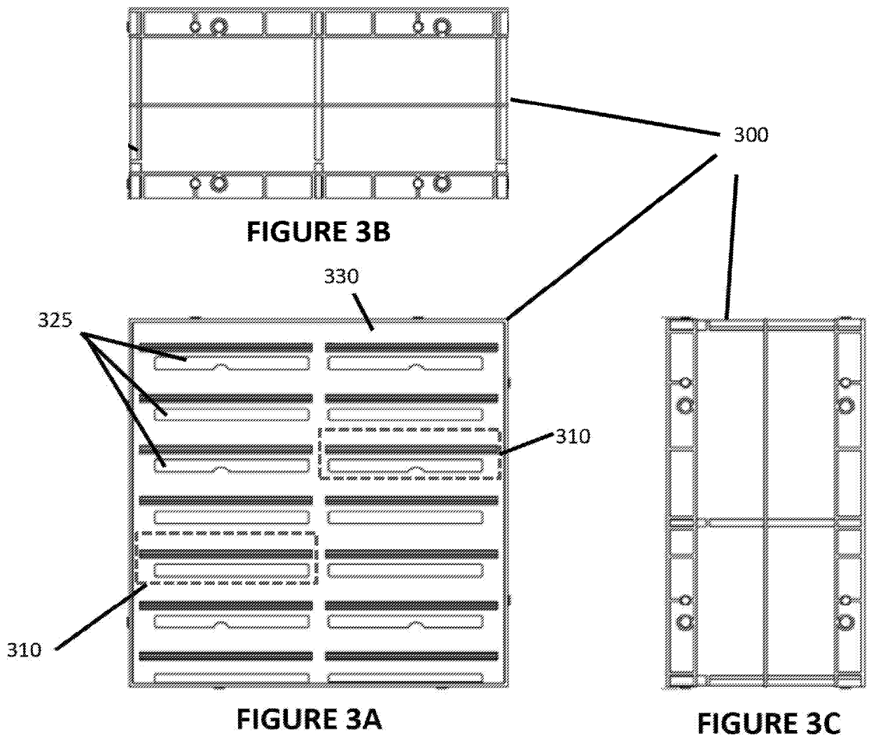

FIG. 3A shows an image of an inlet side/face, or front view of the system shown in FIG. 2. FIG. 3B shows a top view and FIG. 3C shows a side view, of an example sealed filter/filtration system 300 (e.g. system 200 of Fig, 2) comprising a plurality of system inlets 325 for allowing air to flow into compartments 310 each configured to house a cyclonic an⁻ay 270. In some embodiments, upon the closing off the inlet side of the gas filtration system 300 with a cover 330 (e.g. cover 230), the cover inlets 325 are aligned with the first or inlet section (e.g,, lower half) of the compartment 210 (indicated by the outline 310 on the frame or cover 330) which is in fluid communication with the bottom of the array i.e. the inlets of the cyclonic elements in the filtering array 270. In other words, for an assembled filtration system 300, in some embodiments, the system inlets 325 can serve as inlets for allowing contaminated gas, to be treated by the filtration system 300, into the compartments (indicated by the outline 310) of the filtering system 300.

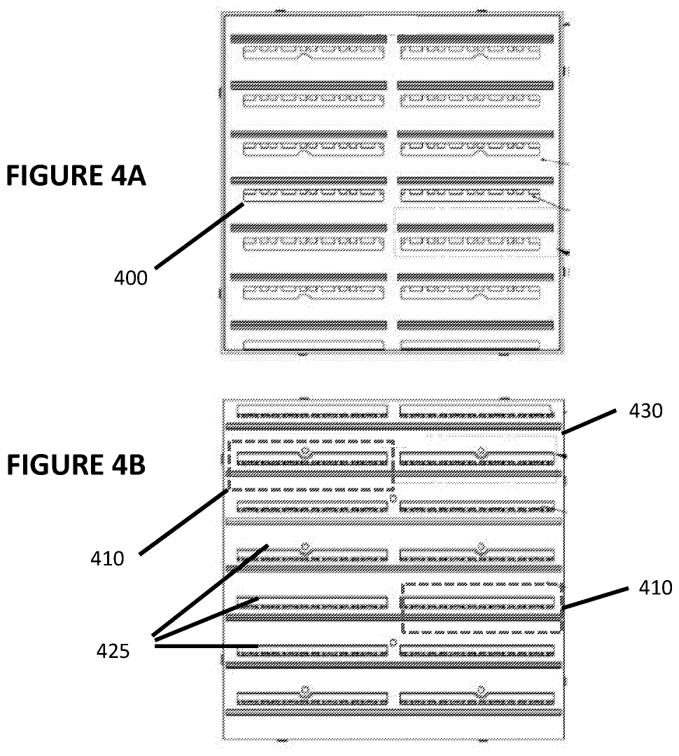

FIG. 4A shows an image of the front inlet side and FIG. 4B shows an image of the back outlet side of an example sealed air filtration system. FIG. 4A may be similar to FIG. 3A which is the front view of FIG. 2. The back side comprises a plurality of outlets for allowing air treated by filtering arrays housed within compartments of assembled gas filtration system 400 (e.g. system 300 or system 200) to flow out of the air filtration system 400, according to some embodiments. In sonic embodiments, a cover 430 may be used to close off a side of the gas filtration system, providing a hermetic seal with the edge of the filtering array 270 (FIG. 2) facing the compartment's open side. In such embodiments, the hermetic seal between the array mating part 280 (the entire, or at least part of the, perimeter mating part circumscribing the filtering array 270) and the compartment mating part 250 (the perimeter mating part running the entire, or at least part of the, circumference of the interior of the compartment 210) results in the interior space of each compartment 210 being divided up into two sections, one of the sections being the second or “outlet” section (e.g., upper half) which is in fluid communication with the outlets 130 of the cyclonic elements in the filtering array 270 (FIG. 2). In some embodiments, the cover 430 may be placed over the back so that a system outlet 425 is aligned with the second or outlet section (e.g., upper half) of the compartment 410 (indicated by the outline 410 on the cover 430 and may be similar to compartment 210 in FIG. 2) which is in fluid communication with the outlets 130 of the cyclonic elements in the filtering array 270. In other words, for an assembled gas filtration system 400, in some embodiments, the system outlets 425 can serve as outlets for allowing gas treated by the filtering array 270 of the filtration system 400 to exit the filtering system 400 itself.

In some embodiments, the hermetic seals between the compartment mating part 250 and the array mating part 280 within each compartment may at least substantially prevent the flow of the gas from the inlet section to the outlet section except via the intended paths going through the cyclonic elements of the filtering array 270. As such, gas slated for treatment by the gas filtration system 200, 300 or 400 enters the system via the system inlets 325 into the first or inlet sections of the compartments of the system and proceed to enter the cyclonic elements of the filtering array 270 via the tangential inlets 120 of the cyclonic elements 110 (FIG. 1A) that are in fluid communication with the inlet sections of the compartments. In some embodiments, the gas passes through the cavities of the cyclonic elements 110 and some or all contaminants contained within the gas may be removed according to the principles of cyclonic separation (e.g., as described above). In some embodiments, the treated gas may then be expelled out of the cyclonic elements via the axial outlets 130, into the second or outlet section of the compartments of the filtration system. The treated gas may then exit the compartments and the system via the system outlets 425 from where it can be directed with the help of fans and/or conduits to its destination,

In order to facilitate even large volumes of air flow, multiple systems can be combined by stacking or tiling them together like bricks in a wall, with one side of this wall representing all the inlets and the other side the outlets.

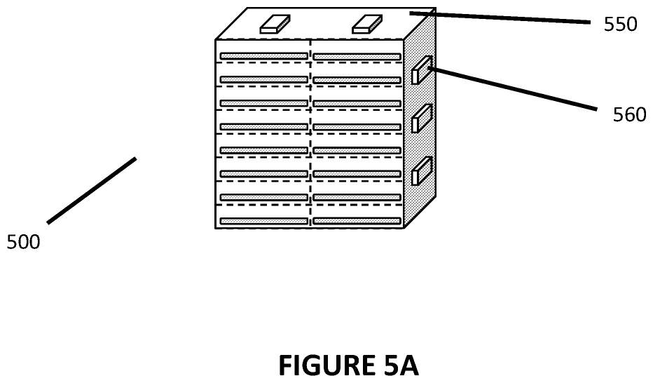

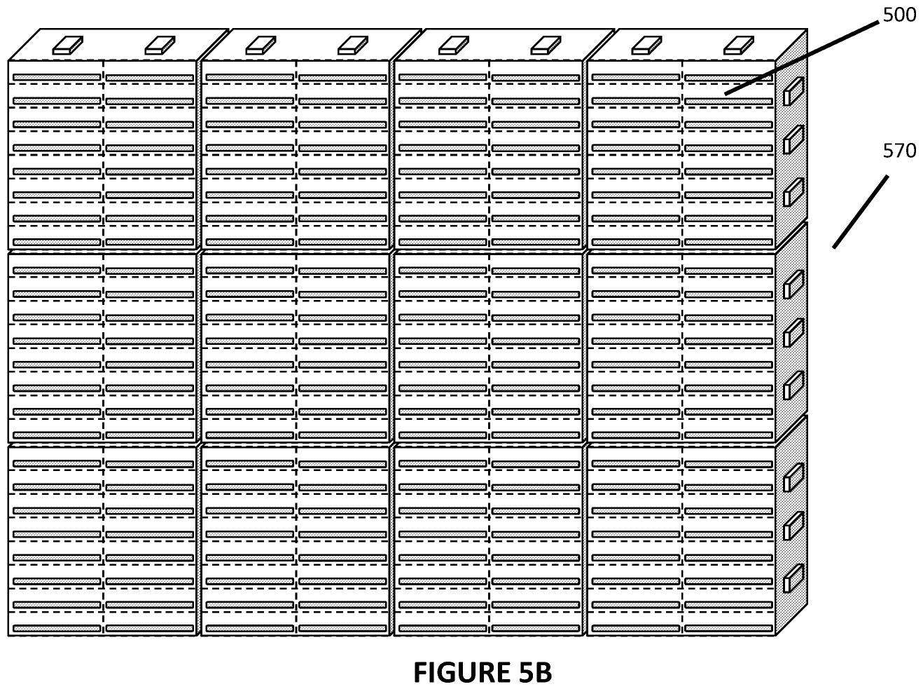

FIG. 5A shows an embodiment of a modular system, or module 500, with sixteen (16) compartments (similar to compartment 210 of FIG. 2, although in that case there are only 14 compartments), each comprising an array and a corresponding inlet section and outlet section. These compartments are arranged as two columns with eight (8) compartments in each column. In some embodiments, a housing 550 of the module is further configured with external features 560 to facilitate alignment or attachment of akija.cent modules. It is appreciated that any suitable number of compartments may be selected. For a non-limiting example, the module may comprise any suitable number of compartments, such as, in a range of 2-2000 compartments, or in some embodiments between about 4-10 compartments, or about 8l-40 compartments, or about 20-10 compartments, or about 80-1000 compartments, or more than about 1000 compartments and subranges thereof.

FIG. 5B shows an assembly 570 of twelve (12) modules 500 similar to the one shown in 5A, tiled together so as to make a larger air filtration system, like bricks forming a wall. Here, the front (inlet) sides of the systems are shown. The wall can be as large as needed and the modular structure allows using a single module design to provide a variety of filtration solutions for different size systems, by stacking or tiling modules 500. The alignment features can be configured/designed to mate or interlock with matching or complementary features on the opposite side, The features can be of any form and size. in some embodiments, the features are linear or rectangular. In some embodiments, the features are circular or circular-like. In some embodiments the features are a dovetail or dovetail-like or a chevron or chevron-like. It is appreciated that any suitable number of modules may be selected. For a non-limiting example, the assembly may comprise any suitable number of modules, such as, in a range of 2-2000 modules, or in some embodiments between about 4-10 modules, or about 8-40 modules, or about 20-100 modules, or about 80-1000 modules, or more than about 1000 modules and subranges thereof.

In some embodiments, the air-filter (e.g. module 500 of FIG. 5A or assembly 570 of FIG. 5B) comprises at least one housing (e.g. 550 of FIG. 5A) configured for placement within an airflow system. The housing may include a frame, having a plurality of frame sides. In The frame sides may include a front frame side shown as front cover 230 in FIG. 2 and also shown in the view of FIGS. 3A and 4A. The frame sides may further include, inter al/a, a top side (FIG. 3B) a frame side (FIG. 3C), and a back side (FIG. 4B). The air inlet side may be in the vicinity of the front cover 230 and the air outlet side may be in the vicinity of back side shown in FIG. 4B. A plurality of isolated compartments 210 (FIG. 2) may be arranged within the housing. At least one array 270 may divide a respective compartment 210 into an inlet section (e.g., lower half of the compartment 210) and an outlet section (e.g., upper half of the compartment 210). The air inlet side of the filter includes a plurality of filter air inlets (e.g. inlet 325 of FIG. 3A), each configured to provide an airflow into a respective inlet section of a respective compartment 210. The air outlet side of the filter includes a plurality of filter air outlets (e.g. outlet 425 of FIG. 4B), each configured to communicate an airflow out of a respective outlet section of a respective compartment.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be an example and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, apparatus, article, material, kit, step and/or method described herein. In addition, any combination of two or more such features, systems, apparatuses, articles, materials, kits, steps, and/or methods, if such features, systems, apparatuses, articles, materials, kits, steps, and/or methods are not mutually inconsistent, is included within the inventive scope of the present disclosure. Some embodiments may be distinguishable from the prior art for specifically lacking one or more features/elements/functionality (i.e., claims directed to such embodiments may include negative limitations

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in coni unction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to he open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is currently claimed:

1. An air-filter comprising:
at least one housing configured for placement within an airflow system, each housing including:
a frame, having a plurality of frame sides;
an air inlet side and an air outlet side;
a plurality of isolated compartments arranged within the housing; and
a plurality of cyclonic filtering arrays,
wherein:
at least one array divides a respective compartment into an inlet section and an outlet section,
the air inlet side of the filter includes a plurality of air inlets, each configured to provide an airflow into a respective inlet section of a respective compartment,
the air outlet side of the filter includes a plurality of air outlets, each configured to communicate an airflow out of a respective outlet section of a respective compartment,
and
each array:
comprises a plurality of organized, attached cyclonic separator elements;
is configured to fit within a respective compartment such that an airflow flowing from the inlet section of the compartment to the outlet section of the compartment, flows exclusively by passing from inlets of the cyclonic elements to outlets of the cyclonic elements.

2. The filter of claim 1, wherein at least one of the housing, the inlet side, the outlet side, and the compartments are configured such that an array can be repeatedly inserted and respectively removed in and from a compartment.

3. The filter of claim 1 or 2, wherein at least one frame, inlet side, or outlet side of the housing is configured to connect with a corresponding side of an adjacently placed housing, such that a plurality of housings can be assembled together to at least one of increase capacity or air flow of the filter.

4. The filter of claim 3, wherein housings are assembled together:
via fixed or removable attachment, and/or
are configured for stacked or tiled arrangement.

5. The filter of claim 3, wherein a plurality of housings are connected such a airflow through each is conducted in parallel.

6. The filter of claim 3, wherein a plurality of housings are connected such that air cannot flow through any gaps between them.

7. The filter of claim 1, wherein each array includes an array perimeter which mates with an inside compartment perimeter of a respective compartment. The filter of claim 7, wherein an array is configured to mate with a respective compartment via a mating means,

9. The filter of claim 8, wherein the mating means comprises at least one of: a seal, a channel arranged on at least one of the inside perimeter of each compartment and each array perimeter, and a guide arranged on the remaining one of each inside perimeter and each array perimeter, wherein each channel is configured to mate with a respective guide.

10. The filter of any of claims 1-9, wherein each inlet section of each compartment is configured to receive the airflow from a respective inlet side of the housing.

11. The filter of any of claims 1-10, wherein each outlet section of each compartment is configured to expel the airflow from a respective outlet side of the housing.

12. The filter of any of claims 1-11, wherein the airflow system comprises an HVAC system.

13. An air-filter comprising:
at least one housing configured for placement within an airflow of a building airflow system, each housing including:
a frame, having a plurality of frame sides;
an air inlet side and an air outlet side;
a plurality of isolated compartments arranged within the housing; and
a plurality of cyclonic filtering arrays, wherein:
each array:
comprises a plurality of organized, parallel attached cyclonic elements;
is configured to mate with a respective compartment via a mating means; and
the mating means comprises at least one of a seal, a channel arranged on at least one of the inside perimeter of each compartment and each array perimeter, and a guide arranged on the remaining one of each inside perimeter and each array perimeter, wherein each channel is configured to mate with a respective guide.

14. The filter of claim 13, wherein:
at least one array divides a respective compartment into an inlet section and an outlet section.

15. The filter of any of claim 13 or 14, wherein the air inlet side of the system includes a plurality of air inlets, each configured to provide an airflow into a respective inlet section of a respective compartment.

16. The filter of any of claims 13-15, wherein the air outlet side of the system includes a plurality of air outlets, each configured to communicate an airflow out of a respective outlet section of a respective compartment.

17. The filter of any of claims 13-16, wherein each array is additionally configured to fit within a respective compartment such that an airflow flowing from the inlet section of the compartment to the outlet section of the compartment, flows exclusively by passing from inlets of the cyclonic elements to outlets of the cyclonic elements.

18. The filter of any of claims 13-17, wherein:
at least one of the housing, the inlet side, the outlet side, and the compartments are configured such that an array can be repeatedly inserted and respectively removed in and from a compartment, and/or
at least one frame, inlet side_{;} or outlet side of the housing is configured to connect with a corresponding side of an adjacently placed housing, such that a plurality of housings can be assembled together to at least one of increase capacity or particle filtering size of the filter.

19. An air-filtration method comprising:
determining a filtration requirement of an air stream;
providing the air filter of claim 3;
configuring the air-filter by assembling a plurality of housings together to form. the air-filter of claim 3 so as to meet or exceed the filtration requirement; and
placing the filter in an airflow received from the at least one room.

20. The method of claim 19, wherein the filtration requirement comprises at least one of filtration capacity oftbe filter and particle size capture ability.
